(19) United States
(12) Patent Application Publication
(10) Pub. No.: US 2011/0279477 A1
(43) Pub. Date: Nov. 17, 2011

(54) Medical Image Processing and Handling System

(76) Inventors: Guishen Wang, Woodbury, MN (US); Jian Mao, Minneapolis, MN (US); Duane Herberg, Little Canada, MN (US); Kevin Dillon, Chanhassen, MN (US); Suzann R. Mouw, White Bear Lake, MN (US); Paul H. McDowall, Eden Prairie, MN (US)

(21) Appl. No.: 13/106,372

(22) Filed: May 12, 2011

Related U.S. Application Data
(60) Provisional application No. 61/333,991, filed on May 12, 2010.

(51) Int. Cl. G09G 5/00

(52) U.S. Cl. 345/629

(57) ABSTRACT

An image processing and handling system is provided for the efficient combination of image data from multiple sources and of different types. The system includes an image processing device having an electronic control unit (ECU) that receives a first set of image data from an image data provider such as a PACS server over a telecommunications network. The first set of image data includes image pixel data from a first image of a physical structure in a living being and may be obtained from a DICOM compatible file. The ECU is further configured to combine the first set of image data with a second set of image data to form a combined set of image data. The second and combined sets of image data may each include pixel data for second and combined images, respectively of the physical structure. The ECU is further configured to transmit the combined set of image data to a remote computing device over a second telecommunications network

This application claims the benefit of U.S. Provisional Patent Application No. 61/333,991 filed May 12, 2010, which is hereby incorporated by reference as though fully set forth herein.

### BACKGROUND OF THE INVENTION

a. Field of the Invention

This invention relates to a system for processing and handling medical images. In particular, the instant invention relates to a system that is able to efficiently retrieve, combine (e.g., process and register both static and dynamic images), and transmit images of multiple types from multiple sources and to multiple destinations for a variety of reasons including diagnosis, therapy delivery, retrospective analysis, research, student and clinician training, and the overall improvement of patient care and positive therapy outcomes.

b. Background Art

Images of physical structures in living beings are generated using a wide variety of devices found in diagnostic and/or treatment centers including, for example, magnetic resonance imaging (MRI) systems and computed tomography (CT) systems. For ease of storage, retrieval and use, these images are often organized and maintained in a picture archiving and communications system (PACS). Further, the image pixel data and other data associated with such images are frequently organized in a common file format specified under a standard published by the National Electrical Manufacturers Association known as Digital Imaging and Communications in Medicine (DICOM). The DICOM image files can be downloaded from a PACS server and viewed on a workstation or similar device.

In addition to the ability of display the aforementioned images, it is desirable for diagnostic and treatment systems to be able to retrieve and make use of the images. For example, in electrophysiology (EP) laboratories, it is often desirable to combine the images with an electroanatomical map created by an electrophysiological mapping system such as the system marketed commercially under the trademark EnSite by St. Jude Medical, Inc. Typically, an image file is downloaded from the PACS server at a facility to portable media such as a compact disc, transported to the diagnostic or treatment device at the facility and then uploaded to the device for use by the device. This process is inefficient and limits the control of EP lab clinicians.

Although it would be desirable to integrate diagnostic and treatment devices with a facility's picture archiving and communications system over a telecommunications network, doing so may require site specific modifications to the device thereby rendering such integration impractical particularly where a given manufacturer has multiple devices with varying functionality at a facility. As a result, many devices are unable to achieve increased functionality that might be available if fully integrated with a facility's telecommunications network.

The inventors herein have recognized a need for an image processing and handling system having increased capabilities to interact with various devices across a telecommunications network and that will minimize and/or eliminate one or more of the above-identified deficiencies. And the inventors herein suggest that at least one issued U.S. patent and several published pending U.S. patent applications could assist those of skill in the art in understanding additional facets and aspects of this disclosure; namely, U.S. Pat. No. 7,640,171 and U.S. Published Application Nos. 20100049740, 20070109402, 20060116583, 20040068423, 20020038381, 20020035638, 20020028007 and 20020023172, respectively, the contents of each of which are hereby incorporated as if fully set forth herein.

### BRIEF SUMMARY OF THE INVENTION

It is desirable to provide an image processing device. In particular, it is desirable to provide an image processing device that can efficiently retrieve, combine, and transmit images of multiple types from multiple sources and to multiple destinations.

An image processing device in accordance with one embodiment of the invention includes an electronic control unit configured to receive a first set of image data from an image data provider over a first telecommunications network, the first set of image data including image pixel data from a first image of a physical structure in a living being. The electronic control unit is further configured to combine the first set of image data with a second set of image data to form a combined set of image data, the second set of image data including image pixel data from a second image of the physical structure and the combined set of image data including image pixel data for a combined image of the physical structure. The electronic control unit is further configured to transmit the combined set of image data to a remote computing device over a second telecommunications network.

An image processing device in accordance with the above described embodiment is advantageous because it enables the efficient retrieval, combination, and transmission of images of multiple types from multiple sources and to multiple destinations. Further, the device permits greater control over, and efficiency in, procedures administered by EP clinicians, among other patient care providers.

The foregoing and other aspects, features, details, utilities and advantages of the present invention will be apparent from reading the following description and claims, and from reviewing the accompanying drawings.

### BRIEF DESCRIPTION OF THE DRAWINGS

FIG. 1 is diagrammatic view of an image processing and handling system in accordance with the present teachings.

FIG. 2 is a diagrammatic view of an image processing device in accordance with one embodiment of the present teachings.

FIG. 3 is a perspective view of a portion of the device of FIG. 2.

FIG. 4 illustrates a graphical user interface for use with the image processing device of FIG. 2.

FIG. 5 illustrates another graphical user interface for use with the image processing device of FIG. 2 that may be accessed from the graphical user interface illustrated in FIG. 4.

FIG. 6 illustrates another graphical user interface for use with the image processing device of FIG. 2 that may be accessed from the graphical user interface illustrated in FIG. 4.

FIG. 7 illustrates another graphical user interface for use with the image processing device of FIG. 2 that may be accessed from the graphical user interface illustrated in FIG. 4.

### DETAILED DESCRIPTION OF EMBODIMENTS OF THE INVENTION

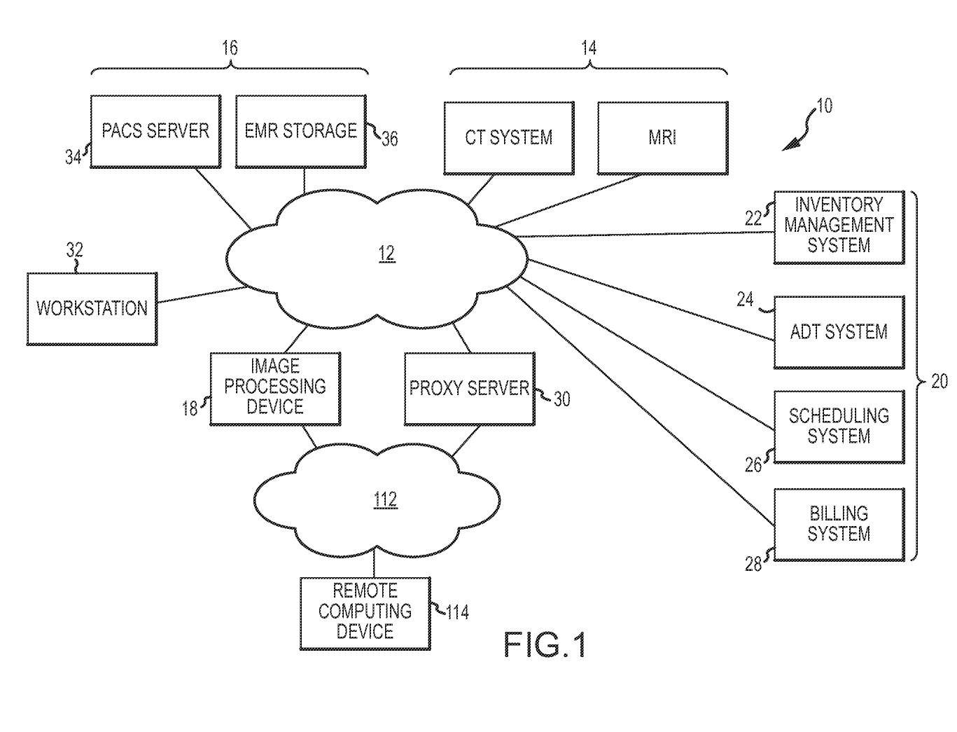

Referring now to the drawings wherein like reference numerals are used to identify identical components in the various views, FIG. 1 illustrates one embodiment of an image processing and handling system 10. System 10 may include a variety of devices and systems configured to communicate with one another over a telecommunications network 12. For example, system 10 may include image data providers such as image generating systems 14 and image storage systems 16. In accordance with one aspect of the present invention, system 10 includes an image processing device 18 that combines data from one or more of image generating and/or image storage systems 14, 16 with other image data. System 10 may also include office systems 20 including, for example, an inventory management system 22, a patient admission, discharge and treatment (ADT) tracking system 24, a clinician scheduling system 26, and a payment/bill processing system 28. In accordance with another aspect of the present invention, system 10 may also include a proxy server 30 to facilitate transmission of data between device 18 and other components of system 10. System 10 may further include various workstations 32 that may include, for example, personal computers, terminals or displays.

Network 12 is provided to enable communication between systems 14, 16, device 18, office systems 20, server 30 and workstations 32. Although network 12 may comprise the public internet, network 12 is typically a private network connecting systems physically located at and/or used by a diagnostic or treatment center such as a hospital or outpatient facility. Network 12 may comprise a local area network (LAN), wide area network (WAN), virtual private network (VPN) or other form of telecommunications network and network 12 may comprise an intranet or extranet.

Image generating systems 14 are provided to generate images of physical structures in a living being. In one embodiment of the invention, the structure of interest is a cardiac structure such as the heart as a whole or some portion thereof. Systems 14 may include, for example, external imaging systems such as magnetic resonance imaging (MRI) systems capable of generating two-dimensional and three-dimensional images of the structure, computed tomography (CT) systems including positron emission tomography (PET) systems and single photon emission computed tomography (SPECT) systems, fluoroscopic imaging systems, ultrasound imaging systems capable of generating two-dimensional or three-dimensional images, systems capable of generating three dimensional rotational angiography (3DRA) images and systems capable of generating images of the structure based on echocardiogram (ECG) signals. Systems 14 may also include internal imaging systems including, for example, intracardiac echocardiography (ICE) ultrasound systems, endoscopic imaging systems, and systems capable of generating images of the structure based on intracardiac electrogram (EGM) signals. Systems 14 may also include imaging systems capable of generating images of the structure based on information obtained from the foregoing systems including, for example, systems for volume rendering of information from, for example, CT image information to generate volume rendered images and systems capable of registering and fusing or merging image information from multiple imaging systems. Systems 14 may be found, for example, in radiology, cardiology and orthopedic sections or facilities and in electrophysiology (EP) laboratories.

Image storage systems 16 are provided to archive or store images and related data and provides a means for aggregating, storage and retrieval of the images and data. Systems 16 may include, for example, a picture archiving and communications systems (PACS) server 34. Systems 16 may also include an electronic medical record (EMR) storage system 36 capable of storing images along with other medical information relating to a patient (e.g., clinician notes, prescriptions, allergies, medical histories, etc.). Systems 16 may store images in a file format in accordance with the digital imaging and communications in medicine (DICOM) standard (e.g., DICOM version 3.0 or DICOM3) promulgated by the National Electrical Manufacturers Association. Files in accordance with this format will include a header with meta information in a tagged file format including, for example, identifying information for the patient, series, or study to which the information in the file relates, and image pixel data and other data. Additional information regarding the file format can be found in the published standard titled “Digital Information and Communications in Medicine (DICOM) PS 3.1 2009,” National Electrical Manufacturers Association (copyright 2009), the entire disclosure of which is incorporated herein by reference. Image generating systems 14 can be configured to generate DICOM compatible image files. Alternatively, non-DICOM compatible image files can be converted to DICOM compatible image files using conventional converters.

PACS server 34 is provided to archive medical images for subsequent retrieval and use. Server 34 is conventional in the art and may communicate with various electronic storage devices including devices for writing and reading to electronic storage media such as compact discs. Server 34 is typically configured to archive files in accordance with the DICOM standard. Server 34 may, for example, comprise a server running software sold under the trademark “HORIZON MEDICAL IMAGING” by McKesson Corp. or under the trademark “SYNGO.PLAZA” by Siemens AG.

EMR storage system 36 is provided to aggregate and archive a variety of information associated with individual patients. This information may include, for example, medical images (including DICOM images), prescription information, family histories and other information.

Image processing device 18 is provided to process image data obtained from image data providers such as image generating systems 14 and image storage systems 16 for users such as clinicians. As discussed hereinbelow, in accordance with one aspect of the invention, image processing device 18 is provided to combine a set of image data obtained from any of systems 14, 16 with another set of image data generated by the processing device 18 and relating to the same physical structure to form a combined set of image data relating to the structure.

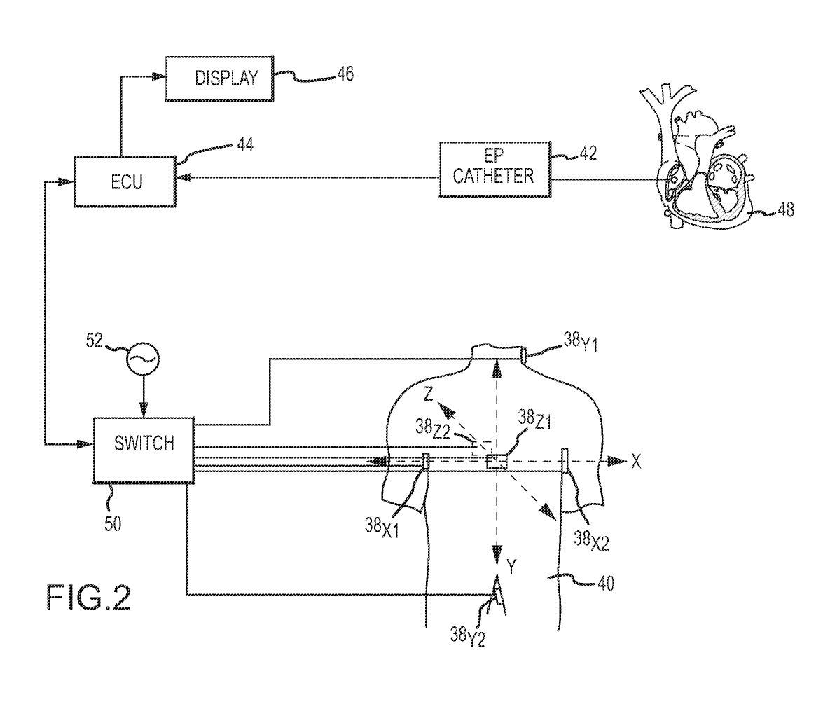

Device 18 may, for example, comprise the electroanatomical mapping and catheter navigation system offered commercially under the trademark “ENSITE” by St. Jude Medical, Inc. Certain aspects of this system are described, in part, in commonly assigned U.S. Pat. No. 7,263,397, the entire disclosure of which is incorporated herein by reference. In the “ENSITE” system, surface electrode patches are applied in several locations on a body. Electrical signals are transmitted between the patches and one or more electrodes supported within a catheter in the body detect changes in voltage and generate signals that are used to generate an image of a tissue surface. Although the ENSITE system may be used with a variety of conventional catheters and electrodes, the system may be used together with the catheter offered commercially by St. Jude Medical under the registered trademark “ENSITE ARRAY.” This catheter includes multiple electrodes that produce an EP map without requiring contact between the electrodes and the tissue surface. Referring to FIG. 2, device 18 may include a plurality of patch electrodes 38 applied to the body 40, an electrophysiological (EP) catheter 42, an electronic control unit (ECU) 44 and a display 46. Although device 18 is described herein as an electroanatomical mapping system, it should be understood that device 18 could perform other functions in addition to, or as an alternative to, mapping. For example, device 18 may be used for treatment of cardiac arrhythmias (e.g., fibrillation, flutter or tachycardia) through catheter-based ablation using various types of ablation energy (e.g., radiofrequency, ultrasound, laser and other light based energy modalities, cryoablation, etc.)

Patch electrodes 38 are provided to generate electrical signals used in determining the position of catheter 42 and in generating EP data regarding tissue such as cardiac tissue 48. Electrodes 38 may also be used in determining the position of, and guiding, a treatment device (not shown) such as an ablation catheter. Electrodes 38 are placed orthogonally on the surface of body 40 and are used to create axes specific electric fields within body 40. Electrodes 38_{X1}, 38_{X2} may be placed along a first (x) axis. Similarly, electrodes 38_{Y1}, 38_{Y2} may be placed along a second (y) axis and electrodes 38_{Z1}, 38_{Z2} may be placed along a third (z) axis. Each of the electrodes 38 may be coupled to a multiplex switch 50. ECU 44 is configured through appropriate software to provide control signals to switch 50 and thereby sequentially couple pairs of electrodes 38 to a signal generator 52. Excitation of each pair of electrodes 38 generates an electrical field within body 40 and within an area of interest such as tissue 48. Voltage levels at non-excited electrodes 38 are filtered and converted and provided to ECU 44 for use as reference values. Although the illustrated image processing device 18 and the “ENSITE” system rely on electrical fields to determine position and orientation, it should be understood that other systems could alternatively be used. For example, device 18 could employ the magnetic field based position and orientation detection system and related technology developed by MediGuide Ltd. under the trademark “gMPS” and described in part in U.S. Pat. Nos. 6,233,476, 7,197,354 and 7,386,339, the entire disclosures of which are incorporate herein by reference, or by Biosense Webster under the trademark “CARTO” and described in part in U.S. Pat. No. 6,690,963, the entire disclosure of which is incorporated herein by reference or a combination of electrical and magnetic fields as in the system sold by Biosense Webster under the trademark “CARTO 3” and described in part in U.S. Pat. No. 7,536,218, the entire disclosure of which is incorporated herein by reference.

EP catheter 42 is provided for use in gathering EP data associated with tissue 48 to enable generation of an image of the geometry of the tissue surface and related EP data. Catheter 42 may also allow removal of bodily fluids or injection of fluids and medicine into the body and may further provide a means for transporting surgical tools or instruments within a body. Catheter 42 may be formed from conventional materials such as polyurethane. Catheter 42 is tubular and is deformable and may be guided within a body by a guide wire or other means known in the art. Catheter 42 has a proximal end and a distal end (as used herein, “proximal” refers to a direction toward the body of a patient and away from the physician while “distal” refers to a direction toward the physician and away from the body of a patient). Catheter 42 may be inserted within a vessel located near the surface of a body (e.g., in an artery or vein in the leg, neck, or arm) in a conventional manner and maneuvered to a region of interest in body 40 such as tissue 48.

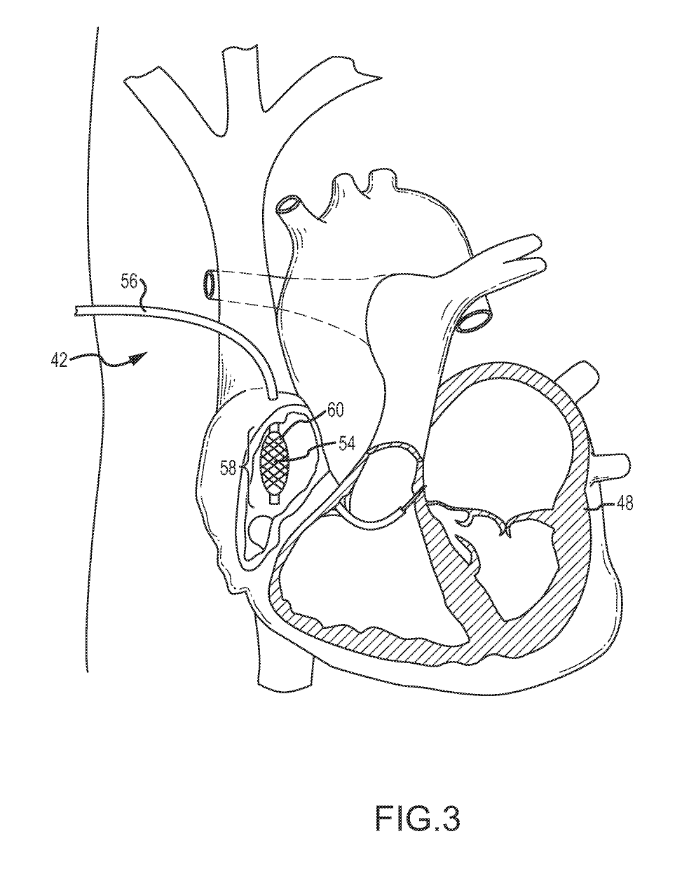

Referring to FIG. 3, EP catheter 42 includes a plurality of EP mapping electrodes 54. The electrodes 54 are placed within electrical fields created in body 40 (e.g., within the heart) by exciting patch electrodes 38. The electrodes 54 experience voltages that are dependent on the location between the patch electrodes 38 and the position of the electrodes 54 relative to tissue 48. Voltage measurement comparisons made between electrodes 38 can be used to determine the position of the electrodes 54 relative to tissue 48. Movement of the electrodes 54 proximate tissue 48 (e.g., within a heart chamber) produces information regarding the geometry of the tissue 48 as well as EP data. For example, voltage levels on the tissue surface over time may be projected on the image of the geometry of the tissue as an activation map. The voltage levels may be represented in various colors and the EP data may be animated to show the passage of electromagnetic waves over the tissue surface. Information received from the electrodes 54 can also be used to display the location and orientation of the electrodes 54 and/or the tip of EP catheter 42 relative to tissue 48.

EP catheter 42 may be a non-contact mapping catheter such as the catheter sold by St. Jude Medical, Inc. under the registered trademark “ENSITE ARRAY.” It should be understood, however, that in at least one embodiment, the present invention may also be used with contact mapping systems in which measurements are taken through contact of the electrodes with the tissue surface. Referring to FIG. 3, catheter 42 includes a deformable tubular body 56 including a deformable distal portion 58. Portion 58 may be formed as a braid of insulated wires 60 with an array of electrodes 54 formed where the insulation on the wires 60 has been removed. Portion 58 may be deformed by expansion (e.g. through use of a balloon) into a stable and reproducible geometric shape to fill a space (e.g., a portion of a heart chamber) after introduction into the space. One or more reference electrodes (not shown) may also be located nearer the distal end of catheter 42 than electrodes 54 and may contact the tissue surface to calibrate the electrode array and maintain the position of the electrode array. An exemplary EP catheter is shown in commonly assigned U.S. Pat. No. 7,289,843, the entire disclosure of which is incorporated herein by reference.

Referring again to FIG. 2, ECU 44 provides a means for generating display signals used to control display 46 and the creation of a graphical user interface (GUI) on display 46. ECU 44 also provides a means for determining the geometry of tissue 48, EP characteristics of tissue 48 and the position and orientation of EP catheter 42 and treatment devices. ECU 44 may further provide a means for controlling various components of system 10 including, but not limited to, treatment devices and switch 50. ECU 44 may comprise a programmable microprocessor or microcontroller or may comprise an application specific integrated circuit (ASIC). ECU 44 may include a central processing unit (CPU) and an input/output (I/O) interface through which ECU 44 may receive a plurality of input signals including signals generated by patch electrodes 38 and EP catheter 42 (and mapping electrodes 54) and generate a plurality of output signals including those used to control and/or provide data to treatment devices, display 46 and switch 50. ECU 44 may be configured to perform various functions with appropriate programming instructions or code (i.e., software).

In operation, ECU 44 generates signals to control switch 50 and thereby selectively energize patch electrodes 38. ECU 44 receives position signals from EP catheter 42 (and particularly mapping electrodes 54) reflecting changes in voltage levels on mapping electrodes 54 and from the non-energized patch electrodes 38. ECU 44 uses the raw location data produced by electrodes 38, 54 and corrects the data to account for respiration and other artifacts. ECU 44 then generates display signals to create an electrophysiological map of tissue 48. ECU 44 may also receive position signals from position sensors on a treatment device. ECU 44 uses the raw location data produced by sensors and again corrects the data to account for respiration and other artifacts. ECU 44 then generates display signals to create an image of treatment device that may be superimposed on the EP map.

Display 46 is provided to convey information to a physician to assist in diagnosis and treatment of tissue 48. Display 46 may comprise a conventional computer monitor or other display device. Display 46 presents a graphical user interface (GUI) to the clinician. The GUI may include a variety of information including, for example, an image of the geometry of the tissue 48, EP data associated with tissue 48, graphs illustrating voltage levels over time for various electrodes, and images of EP catheter 42 and mapping electrodes 54. Examples of the type of information that may be displayed are shown in commonly assigned U.S. Pat. No. 7,263,397, the entire disclosure of which is incorporated herein by reference. The EP map may include both the geometry of the tissue and EP data associated with the tissue. For example, the EP map may include an image of tissue 48 together with color coded indicators illustrating electrical activity at locations in tissue 48. The EP map may comprise a two-dimensional image of tissue 48 (e.g., a cross-section of the heart) or a three-dimensional image of tissue 48. Display 46 may also include an image of the EP catheter 42 and/or mapping electrodes 54 illustrating their position relative to tissue 48 and any treatment devices illustrating their positions.

In accordance with one aspect of the present invention, ECU 44 may be further configured to combine a set of image data obtained from any of systems 14, 16 with another set of image data generated by ECU 44 and relating to the same physical structure (e.g., the EP map) to form a combined set of image data relating to the structure. ECU 44 may obtain images from image generating systems 14 or image storage systems 16 by sending a request to any of systems 14, 16 (i.e., that are “pulled” by device 18). Alternatively, ECU 44 may obtain images from any of systems 14, 16 by accepting transmissions initiated by any of systems 14, 16 (i.e., that are “pushed” to device 18). As discussed in greater detail below, ECU 44 may maintain a profile in a memory for each of systems 14, 16 including information relating to the system such as a descriptive name, IP address, communications port, application entity tile and vendor name that may be used to communicate with the systems 14, 16. ECU 44 may further be configured to identify systems that are subsequently added to system 10 and/or access network 12 or existing systems that are upgraded or otherwise changed by conducting a periodic search for added or changed systems and requesting profile information from added or changed systems, or by receiving profile information broadcast by the systems when changed or added to the network or by monitoring network communications and initiating a request upon detection of an added or changed system. ECU 44 may further be configured to generate a notification across network 12 upon detection and/or identification of an added or changed system to, for example, advise information technology personnel with a facility or organization.

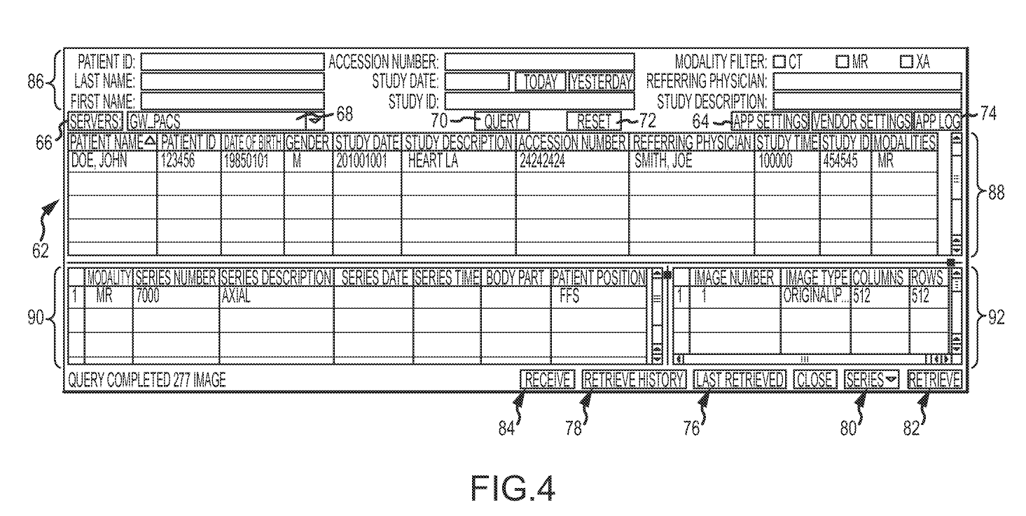

In one embodiment of the invention, ECU 44 includes programming instructions defining an interface module used to access, identify, retrieve, display and manipulate DICOM images that may be obtained, for example, from PACS server 34. The images may be used by a care provider for a various purposes including, for example, comparing a prior condition of a patient to a present condition and in the aggregation of a multitude of patient-specific information including, for example, device-device and drug-drug interaction(s), patient response to therapy and patient physiologic characteristics (e.g., heart rate, blood gas information, weight, age any arrhythmias, myocardial infarction, or adverse events (AEs), patient heart failure status, systolic- and diastolic-cardiac pressures and volumes and the like). Referring to FIG. 4, ECU 44 may generate a GUI 62 on display 46 that enables a clinician to enter search criteria that can be used to search available image files on one or more of storage devices 16 among other functions. GUI 62 may include a plurality of interface elements (e.g., menus, buttons, icons, etc.) 64, 66, 68, 70, 72, 74, 76, 78, 80, 82, 84 configured to perform various functions as described below. GUI 62 may further be divided into four panes 86, 88, 90, 92 associated with entry of search criteria and the display of search results as described in greater detail below.

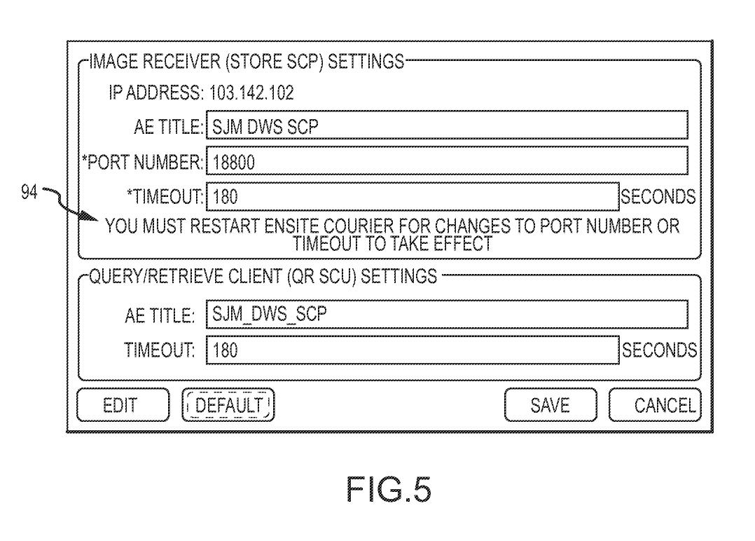

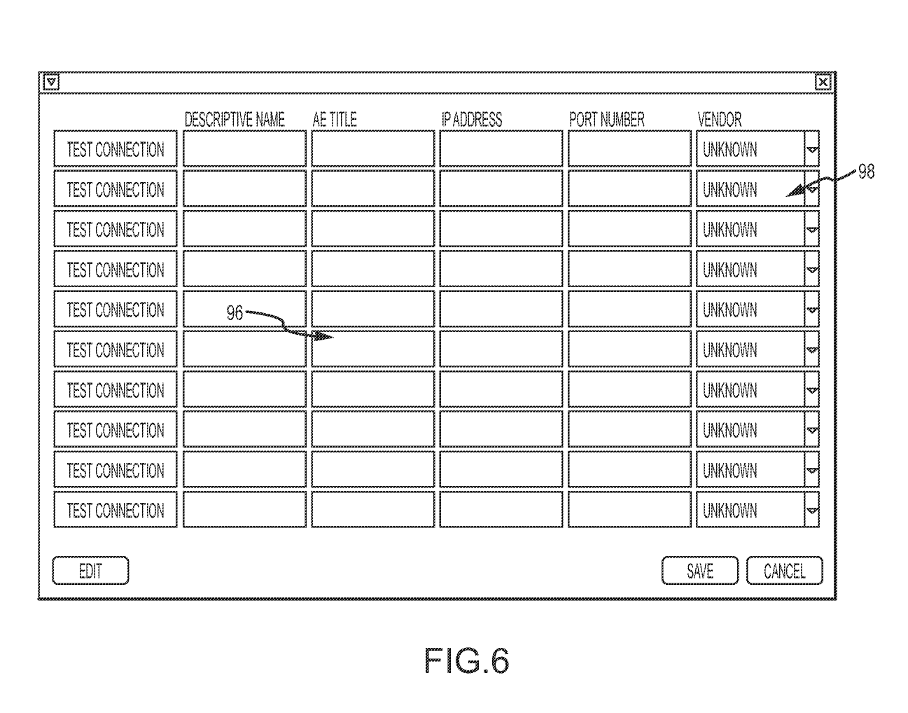

Interface elements 64, 66 are provided to allow the user to configure device 18 and ECU 44 for communication with systems 14, 16. As referenced hereinabove, ECU 44 may maintain a profile in a memory for each of systems 14, 16 including information relating to the system such as a descriptive name, IP address, communications port, application entity title and vendor name that may be used to communicate with the systems 14, 16. Similarly, systems 14, 16 may maintain a similar profile in a memory relating to device 18. The user may enter the information required to establish communication between device 18 and systems 14, 16 using interface elements 64, 66. Referring to FIG. 5, the user may use interface element 64 (see FIG. 4) to generate a graphical user interface (GUI) 94 displaying the configuration settings for device 18. GUI 94 may be displayed in a separate window overlaid on GUI 62. The displayed settings may include the application entity title and port number for device 18 and time limits for receiving images from any of systems 14, 16 that are requested by device 18 and/or “pushed” to device 18. GUI 94 may itself include graphical interface elements to permit editing of the settings, save edited settings and return the settings to default values among other features. Referring to FIG. 6, the user may use interface element 66 (see FIG. 4) to generate a graphical user interface (GUI) 96 displaying the configuration settings for systems 14, 16. GUI 96 may again be displayed in a separate window overlaid on GUI 62. GUI 96 may include fields for entering information regarding systems 14, 16 including descriptive names, the application entity title, IP address and port number for each of systems 14, 16. GUI 96 may further include an interface element 98 such as a menu to allow the user to assign a profile to each of systems 14, 16 relating to the image retrieval capabilities of each system 14, 16. These profiles may include generic profiles (e.g., indicating that the respective system 14, 16 will permit retrieval of (i) studies; (ii) studies and individual series within a study; or (iii) studies, individual series within a study, and individual images within a series) or profiles that are particular to the manufacturer or model of the system 14, 16. GUI 96 may include additional interface elements to permit editing of the configuration settings, saving edited configuration settings and for performing a test of the connection based on the entered settings. In accordance with one aspect of the invention, device 18 may be configured, upon a change in the configuration settings of a device connected to device 18 over network 12, to update the configuration settings in device 18 and/or to act as a network wide configuration manager initiating changes in the profiles of other devices connected to the changed device over network 12.

Referring again to FIG. 4, interface element 68 may comprise a drop down menu used to select the system 14, 16 from which device 18 will receive images. Interface elements 70, 72 are provided to perform a search based on search criteria entered in pane 90 and to clear the search criteria, respectively. Element 74 may be used to access a communications log or record for troubleshooting. Elements 76, 78 may be provided as shortcuts for obtaining the most recently obtained study, series or images or earlier obtained studies, series, or images, respectively. Element 80 may be provided to establish the level at which images will be retrieved (e.g., all images from a selected study, all images from a selected series within a study, or only selected images). Elements 82, 84 may be provided to retrieve images identified from a search or to receive images “pushed” to device 18 by systems 14, 16, respectively.

Panes 86, 88, 90, 92 may be used to enter search criteria and display search results. Pane 86 may be used to enter search criteria to locate an image (a search may then be initiated, for example, using interface element 70 on GUI 62). The search criteria may include, for example, a patient name or other patient identifying information, study or image data (e.g., dates or other identifying information), accession number (identifying, e.g., a discrete patient, study or procedure), modality (e.g., MRI, CT, 3DRA, etc.), physician or descriptive title. The extent of available search criteria is limited only by the available information in the tags associated with the DICOM images and may include private tags added during creation of the image file that are unique to the manufacturer of the device that acquired the image. Pane 88 may display information regarding studies (collections of series of images) that match the search criteria. The information (or attributes) that is displayed may be configured by the user but may include, for example, patient information (name, date of birth, gender or other identifying information), study information (date, time, description or other identifying information), the accession number, physician or modality. Pane 90 may be used to display series information for a study (e.g., by selecting a particular study in pane 88). The information (or attributes) that is displayed may again be configured by the user, but may include, for example, series information (date, time, number, description or other identifying information), the number of images, the modality of the images, or information on the patient (e.g., the position of the patient or the body part being imaged). Pane 92 may be used to display information relating to a particular image (e.g. by selecting a particular series in pane 90). The information (or attributes) that is displayed may again be configured by the user, but may include, for example, the type of image, the image number, and the number of columns and rows in the image.

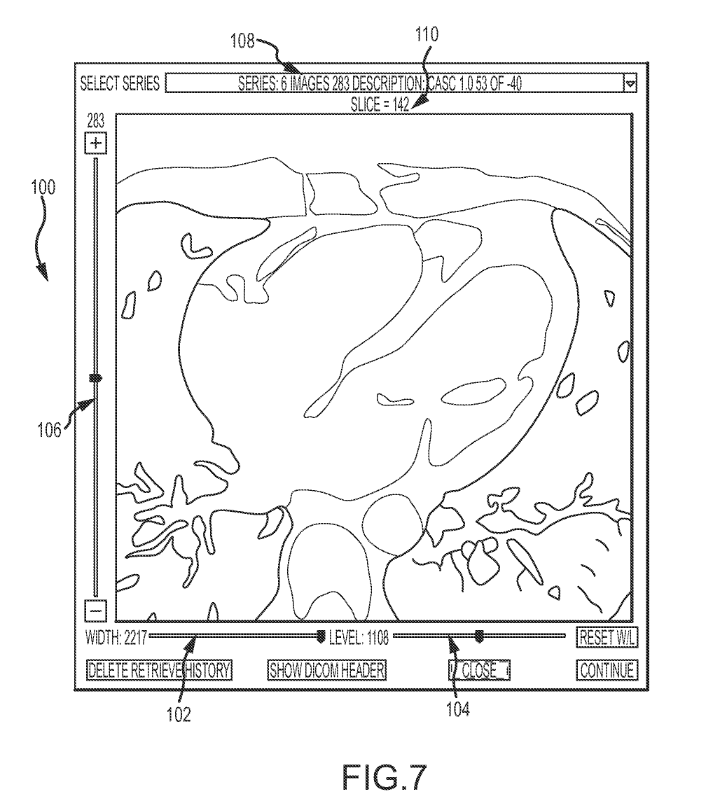

The clinician may select individual images or collections of images (e.g., a series or study comprised of DICOM images) to retrieve from the search. Using GUI 62, after a selection is made, the image may be retrieved by, for example, actuating interface element 82. As noted above, in an alternative embodiment, ECU 44 may receive images that are “pushed” to device 18 by any of systems 14, 16. The user may, for example, actuate interface element 84 to receive such images. GUI 62 may display the status of the request as the image is retrieved or received. Referring to FIG. 7, once images have been obtained, they may be displayed on display 46 in, for example, a viewer 100 in a separate window on display 46 (see FIG. 2) that may be overlaid on GUI 62 (see FIG. 4). In the case of the retrieval or receipt of a series of images, the viewer 100 may display one image (e.g., the middle image) based on predetermined criteria and allow the user to navigate among the other images in the series. Once image files are retrieved, they may also be stored by device 18 (see FIG. 1) in a local or dedicated memory. Viewer 100 may also function as a graphical user interface and provide the user with interface elements such as slides 102, 104 used to adjust the contrast and brightness of the images that are displayed and a slide 106 used to navigate among images in a series. Viewer 100 may also display identification information associated with the image such as a descriptive title 108 and number 110.

ECU 44 is further configured to extract a set of image data from the DICOM image file and combine the image data with another set of image data for the same physical structure (e.g., the EP map) into a combined set of image data using one or more techniques. For example, the “ENSITE” system referenced hererinabove includes a software module offered commercially under the trademark “FUSION” that can be used to register and combine the EP map with three-dimensional MRI or CT images. Registration of the retrieved DICOM image file with the image data generated by device 18 (e.g., the EP map) may be accomplished using identifiable fiducials or landmarks in the image data (including, e.g., visual landmarks or markers in signal traces). Exemplary registrations methods are disclosed in U.S. Pat. Nos. 7,298,881, 7,327,872, 7,512,276 and 7,565,190, the entire disclosures of which are incorporated herein by reference. The image data may be combined in a variety of ways into the combined set of image data to permit varying displays of the images generated from the data. For example, the image data sets may be combined such that an image generated from either set of image data is overlaid or superimposed on an image generated from the other set of image data. Alternatively, the image data sets may be combined such that images generated from both sets of image data sets are displayed side by side or one at a time. Further, in either case, the combined set of image data may reflect modification of one or both image data sets to affect a logical relationship between the images generated from the data sets (e.g. translation or rotation of the image generated from one data set to meet a predetermined characteristic (e.g., size, viewing angle) relative to an image generated from the other data set). Further yet, the image data sets may be combined into a single new image integrating data from the two image data sets. In extracting image data from the acquired image file, ECU 44 may be configured to segment or partition the image data and to generate a revised set of image data (e.g., the creation of a three-dimensional model (a digital image fusion or “DIF” file)) as in the segmentation tool offered commercially under the trademark “VERISMO” by St. Jude Medical, Inc. for combination with the image data generated by device 18. Alternatively, the acquired image file may be a pre-segmented three-dimensional model.

ECU 44 may further be configured to create a DICOM compatible image file including the combined set of image data. This image file may be stored in local memory in ECU 44 and may be transmitted to one or more of image storage systems 16. As discussed in greater detail below and with reference to FIG. 1, in accordance with one aspect of the present invention, the combined image data may also be transmitted to a remote computing device. In accordance with another aspect of the present invention, the combined image data file may include one or more private tags with information that is accessible only to device 18 or authorized systems. This information could be used for system identification, to evaluate system performance, and for clinical and product research and development and could be used to identify and render information and image data types that a given clinician finds relatively more useful (e.g., three- or n-layer registered images such as CT, MRI, ultrasound, PQRST complexes, and the like). Patient-specific information in the image file may be de-identified to comply with the Health Insurance Portability and Accountability Act (HIPPA) of 1996 and HIPPA and European Privacy directive(s), but may be accessible for use by using a pseudo-code surrogate for the patient-specific information.

Referring again to FIG. 1, device 18 may also be connected to, and communicate over, a telecommunications network 112. In the illustrated embodiment, network 112 comprises the public internet. It should be understood, however, that network 112 may comprise a local area network (LAN), wide area network (WAN), virtual private network (VPN) or other form of telecommunications network and network 112 may comprise an intranet or extranet. Further, network 12 may form a portion of network 112 and vice versa. ECU 44 may be configured to access network 112 directly through a public access node or may access network 112 through a secure access point using network 12 (e.g., with firewalls or another conventional access and content control systems). ECU 44 may use network 112 to reach remotely located computing devices 114. Devices 114 may be used, for example, for monitoring, diagnosis and repair of device 18 or updating programming instructions for device 18 (i.e., providing software updates). Devices 114 may also be used to assist in training users of device 18 by, for example, allowing remote control of the interface on device 18 for demonstrations. Devices 114 may also be used for real-time access and manipulation of images from systems 14, 16 within system 10. Devices 114 may also be used to retrieve and/or receive data from device 18 including the combined image data and tagged DICOM files discussed hereinabove. In this manner, devices 114 can aggregate data to assess system operational characteristics or permit clinical research and training. Devices 114 may also be used by patients to provide medical data to device 18. For example, patients may transmit data obtained using in-home monitoring equipment to device 18 over a telecommunications network such as the public internet or a private network such as the networks run under the trademarks “MERLIN” by St. Jude Medical, Inc. or “CARELINK” by Medtronic, Inc. Device 18 can combine this data with image data generated by device 18. Device 18 can also transmit this information to other systems including EMR storage system 36 for aggregation with other patient specific data which can then be accessed by a clinician at a specific facility or organization. The transmission of this information to EMR storage systems 36 may occur automatically under predetermined events for automated EMR archiving and device 18 and/or storage system 36 may be configured with an auto-delete function for deletion of records existing for more than a predetermined time and a de-fragmentation function to maintain EMRs for a given patient (or clinician or type of procedure) together and easily retrievable. Devices 114 could also provide demographic information useful to a clinician in diagnosis and treatment. For example, devices 114 could provide patient demographics for patients undergoing diagnosis or treatment using the same or a similar system to device 18. Devices 114 can also be used for off-site storage of information generated by device 18 including housing electronic medical records.

Referring again to FIG. 1, inventory management system 22 is provided to track a facility or organization's inventory of consumables and other supplies and to provide information on inventory levels, expiration or “use by” date(s), and the like to facility personnel including notices when inventory levels reach predefined thresholds. Inventory management system may also automatically initiate orders to vendors of the consumables or other supplies. In accordance with one aspect of the present invention, ECU 44 may be configured to notify system upon completion of a procedure using a consumable such that inventory levels are adjusted within system 22 and system 22 is able to take any required actions in response to the change inventory levels. In the case of an EP lab, such consumables may include introducers, catheters, sheaths, drugs and irrigation or other fluids or even written or portable electronic storage media.

Admission, discharge and treatment (ADT) tracking system 24 is provided to track patients within a facility. In accordance with another aspect of the present invention, ECU 44 may be configured to notify system 24 regarding the initialization, progress, and/or termination of a procedure on a patient such that system 24 can provide appropriate status reports to clinicians or administrative personnel at a facility or to family members or other persons designated to receive such information by the patient.

Clinician scheduling system 26 is provided for organization of the schedules of individual clinicians and teams of clinicians. System 26 may store clinician-specific information such as expertise, experience, specialization and accreditation status(es) in addition to clinician schedules and work teams to optimize patient and clinician procedure times. In accordance with another aspect of the present invention, ECU 44 may be further configured to notify system 26 regarding the initialization, progress and/or termination of a procedure on a patient and/or the progress of a image rendering procedure so that clinicians and administrative personnel can monitor and adjust schedules of attending clinicians.

Billing system 28 provides accounting and invoice generation functions for the purpose of, among other things, obtaining third party reimbursement for procedure costs via Medicare, Medicaid, insurance companies and the like In accordance with another aspect of the present invention, ECU 44 may be further configured to notify system 28 regarding the termination of a procedure on a patient, the type of procedures performed and the consumables used during the procedure. As a result, billing system 28 can efficiently create an invoice for the procedure. System 28 can further communicate with third party systems, such as insurance company claim and payment systems, over a telecommunications network.

In accordance with another aspect of the invention, proxy server 30 may act as an intermediary between image processing device 18 and network 12. Server 30 provides a connection node between processor 18 and other components of system 10 accessible through network 12 and provides a central pathway through which communications between device and other components of system 10 pass. As used herein for proxy server 30, the term “server” refers to a computing device coupled to a network and configured by programming instructions (i.e., software) to provide services to other computing devices (including other servers). Server 30 may include a conventional operating system such as one of the operating systems sold under the registered trademark “WINDOWS®” available from Microsoft Corporation of Redmond, Wash. It should be understood, however, that other conventional operating systems such as those based on the Linux or UNIX operating systems or operating systems for the Apple computer system (e.g. OS X) may alternatively be used. Server 30 may also include an internal memory or database configured to provide a static and dynamic contact structure for server 30. The database is used to provide both intermediate information while server 30 executes operations and long-term storage of data. The database may employ a database management system (DBMS) such as the DMBS sold under the trademark “SQL SERVER” by Microsoft Corporation of Redmond, Wash. Server 30 further includes applications that configure server 30 to perform the functions described in greater detail hereinafter. The applications may be implemented using conventional software development components and may further include a combination of JavaScript, VB Script and ASP (Active Server Pages) and other conventional software components to provide required functionality. Server 30 also includes a conventional interface to provide a graphical and communications interface between server 30 and device 18. The interface may, for example, be configured to be eXtensible Markup Language (XML) or Simple Object Access Protocol (SOAP) compliant. Although only one server 30 is shown in the illustrated embodiment, it should be understood that proxy server 30 could include multiple servers working cooperatively in one or more known computing architectures

Server 30 is coupled to network 12 and may be configured to perform several functions. In accordance with one aspect of the invention, server 30 may be configured to recognize devices connected to network 12 meeting a predetermined characteristic. In this manner, proxy server 30 can serve as a connection point for devices having a common characteristic. One common problem in medical environments is the need to allow interoperability and interconnection among a wide variety of systems from various manufacturers. The systems of any given manufacturer often must be uniquely configured to an installation site in order to permit use of a local telecommunications network. Proxy server 30 eliminates the need to configure each device of the manufacturer. Instead, proxy server 30 is configured as required for communications with the local network and is configured to operate with a particular manufacturer's devices. Thereafter, as new or updated systems are installed by the manufacturer, no special configuration is required. Instead, communications flow through the proxy server 30 which recognizes the configurations of the local network and the manufacturer systems and permits communications between them.

Server 30 can also be configured to store image data and other data intended for delivery to device 18 or another device. As set forth hereinabove, device 18 may be configured to request and retrieve data from systems 14, 16, but can also alternatively be configured to receive data from systems 14, 16 without making a request. The use of proxy server 30 enables device 18 to control the timing of delivery of such data and enables temporary storage of the data in the event that device 18 is disabled or otherwise disconnected from network 12.

Server 30 can also be configured for communication over network 112 to remote computing devices 114. In this manner, server 30 can provide a common delivery point for content deliveries (software updates, instructions for use, bulletins) to installed devices of a given manufacturer and for remote diagnosis and support.

An image processing and handling system in accordance with the present teachings offers one or more of a number of advantages. First, it enables more efficient handling and use of images from different sources and of different types. Second, it increases the number of procedures that can be performed in a given period of time. Third, it provides heretofore unknown combinations of static and dynamic registered medical images and patient information from diverse fields of medical endeavor. Fourth, it provides network-based image availability over a sustained period of time so a patient can be followed by a variety of clinicians in different locations all sharing common and/or customized data streams.

Although several embodiments of this invention have been described above with a certain degree of particularity, those skilled in the art could make numerous alterations to the disclosed embodiments without departing from the scope of this invention. All directional references (e.g., upper, lower, upward, downward, left, right, leftward, rightward, top, bottom, above, below, vertical, horizontal, clockwise and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not as limiting. Changes in detail or structure may be made without departing from the invention as defined in the appended claims.

What is claimed is:

1. An image processing device, comprising:
an electronic control unit configured to:
receive a first set of image data from an image data provider over a first telecommunications network, said first set of image data including image pixel data from a first image of a physical structure in a living being;
combine said first set of image data with a second set of image data to form a combined set of image data, said second set of image data including image pixel data from a second image of said physical structure and said combined set of image data including image pixel data for a combined image of said physical structure; and,
transmit said combined set of image data to a display.

2. The image processing device of claim 1, further comprising said image data provider.

3. The image processing device of claim 2 wherein said image data provider is a magnetic resonance imaging system.

4. The image processing device of claim 2 wherein said image data provider is a computed tomography system.

5. The image processing device of claim 2 wherein said image data provider is an image storage system.

6. The image processing device of claim 5 wherein said image storage system is a picture archiving and communications systems server.

7. The image processing device of claim 1 wherein said first set of image data is obtained from a DICOM compatible file.

8. The image processing device of claim 1, further comprising a proxy server, wherein said first set of image data is transmitted from said image data provider to said image processing device through said proxy server.

9. The image processing device of claim 8 wherein said combined set of image data is transmitted through said proxy server

10. The image processing device of claim 8 wherein said proxy server is configured to recognize devices connected to said first telecommunications network meeting a predefined characteristic.

11. The image processing device of claim 1, wherein said electronic control unit is further configured to transmit said combined set of image data to a remote computing device over a second telecommunications network.

12. The image processing device of claim 1, wherein said electronic control unit is further configured to determine a position of a catheter electrode relative to said physical structure responsive to electrical signals generated by said catheter electrode.

13. An image processing system comprising:
a set of surface patch electrodes configured to be applied to a living being; and
an electronic control unit configured to:
receive a first set of image data from an image data provider over a first telecommunications network, said first set of image data including image pixel data from a first image of a physical structure in said living being;
combine said first set of image data with a second set of image data to form a combined set of image data, said second set of image data including image pixel data from a second image of said physical structure and said combined set of image data including image pixel data for a combined image of said physical structure;
transmit said combined set of image data to a display; and,
determine a position of a catheter electrode relative to said physical structure responsive to electrical signals generated by said catheter electrode.

14. The image processing system of claim 13 wherein said first set of image data is obtained from a DICOM compatible file.

15. The image processing system of claim 13, further comprising a proxy server, wherein said first set of image data is transmitted from said image data provider to said image processing device through said proxy server.

16. The image processing system of claim 15 wherein said combined set of image data is transmitted through said proxy server

17. The image processing system of claim 15 wherein said proxy server is configured to recognize devices connected to said first telecommunications network meeting a predefined characteristic.

18. The image processing system of claim 13, further comprising said image data provider.

19. The image processing system of claim 13 wherein said electronic control unit is further configured to transmit said combined set of image data to a remote computing device over a second telecommunications network.

20. An image processing device, comprising:
means for receiving a first set of image data from an image data provider over a first telecommunications network, said first set of image data including image pixel data from a first image of a physical structure in said living being;
means for combining said first set of image data with a second set of image data to form a combined set of image data, said second set of image data including image pixel data from a second image of said physical structure and said combined set of image data including image pixel data for a combined image of said physical structure;
means for transmitting said combined set of image data to a display;
means for determining a position of a catheter electrode relative to said physical structure responsive to electrical signals generated by said catheter electrode.
